(19) United States
(12) Patent Application Publication
(10) Pub. No.: US 2025/0079742 A1
(43) Pub. Date: Mar. 6, 2025

(54) Connector Terminal Module and Connector

(71) Applicants: Tyco Electronics (Shanghai) Co., Ltd., Shanghai (CN); Tyco Electronics Technology (SIP) Ltd., Suzhou (CN)

(72) Inventors: Yunji He, Suzhou (CN); Jianjia Qi, Shanghai (CN); Feng (Carlos) Pan, Suzhou (CN)

(73) Assignees: Tyco Electronics (Shanghai) Co., Ltd., Shanghai (CN); Tyco Electronics Technology (SIP) Ltd., Suzhou (CN)

(21) Appl. No.: 18/826,804

(22) Filed: Sep. 6, 2024

(30) Foreign Application Priority Data
Sep. 6, 2023 (CN) 202322420549.3

(51) Int. Cl. H01R 13/11; H01R 13/24; H01R 13/428; H01R 13/502; H01R 13/629; H01R 13/639; H01R 13/6581; H01R 24/60; H01R 43/20; H01R 103/00

(52) U.S. Cl. CPC H01R 13/113; H01R 13/2442; H01R 13/428; H01R 13/502; H01R 13/629; H01R 13/639; H01R 13/6581; H01R 24/60; H01R 43/20; H01R 2103/00

(57) ABSTRACT

A connector terminal module includes a retaining body having a terminal hole, a terminal disposed in the terminal hole of the retaining body, a cable having a conductor core electrically connected to the terminal, and a shielding shell including a front shell part fitted onto the retaining body and a rear shell part crimped onto an end of the cable. The front shell part and the rear shell part of the shielding shell are opposite to each other in a longitudinal direction of the shielding shell. The shielding shell is an integral stamped piece.

### CROSS-REFERENCE TO RELATED APPLICATION

This application claims the benefit of the filing date under 35 U.S.C. § 119 (a)-(d) of Chinese Patent Application No. 202322420549.3, filed on Sep. 6, 2023.

### FIELD OF THE INVENTION

The present invention relates to a connector terminal module and a connector comprising the connector terminal module.

### BACKGROUND

A connector includes a front shielding shell, a rear shielding shell, and a middle shielding shell. The front shielding shell, the rear shielding shell, and the middle shielding shell are assembled together to form a complete shielding shell.

The assembly of existing shielding shells is not only cumbersome but also difficult to locate, reducing the production efficiency of connectors. In addition, this assembled shielding shell also has problems with poor shielding effect and large volume.

### SUMMARY OF THE INVENTION

A connector terminal module includes a retaining body having a terminal hole, a terminal disposed in the terminal hole of the retaining body, a cable having a conductor core electrically connected to the terminal, and a shielding shell including a front shell part fitted onto the retaining body and a rear shell part crimped onto an end of the cable. The front shell part and the rear shell part of the shielding shell are opposite to each other in a longitudinal direction of the shielding shell. The shielding shell is an integral stamped piece.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector terminal module according to an exemplary embodiment;

FIG. 2 shows a longitudinal sectional view of a connector terminal module according to an exemplary embodiment;

FIG. 3 shows another longitudinal sectional view of a connector terminal module according to an exemplary embodiment;

FIG. 4 shows an illustrative exploded view of a connector terminal module according to an exemplary embodiment;

FIG. 5 shows an illustrative perspective view of a shielding shell of a connector terminal module according to an exemplary embodiment;

FIG. 6 shows a longitudinal sectional view of the shielding shell of a connector terminal module according to an exemplary embodiment; and

FIG. 7 shows a longitudinal sectional view of a connector according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

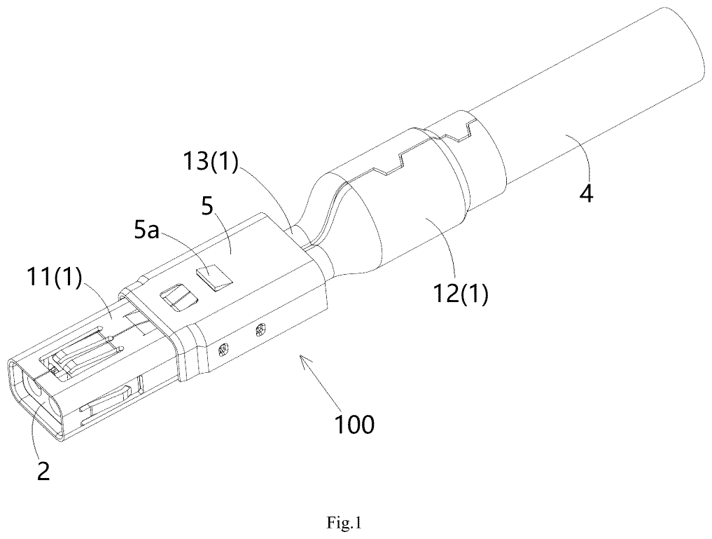

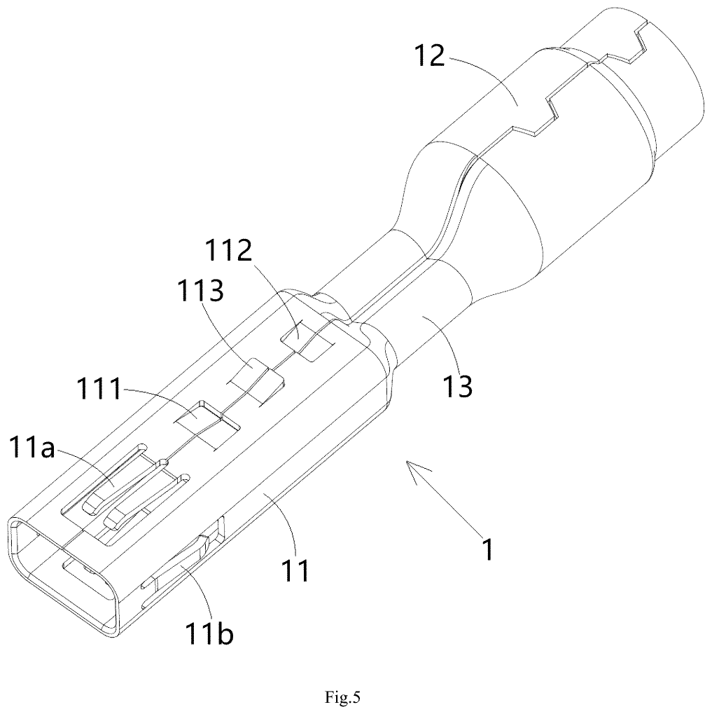

As shown in FIGS. 1 to 6, in an exemplary embodiment of the present invention, a connector terminal module 100 is disclosed. The connector terminal module 100 includes a shielding shell 1, a retaining body 2, a terminal 3, and a cable 4. The retaining body 2 is made of insulating material and is formed with a terminal hole 201. The terminal 3 is inserted into the terminal hole 201 of retaining body 2. The conductor core 41 of the cable 4 is electrically connected to the terminal 3.

As shown in FIGS. 1 to 6, in the illustrated embodiments, the shielding shell 1 comprises a front shell part 11 and a rear shell part 12. The front shell part 11 of shielding shell 1 is fitted onto the retaining body 2. The rear shell part 12 of shielding shell 1 is crimped onto one end of cable 4. The front shell part 11 and rear shell part 12 of the shielding shell 1 are opposite in the longitudinal direction of the shielding shell 1, and the shielding shell 1 is an integral stamped piece.

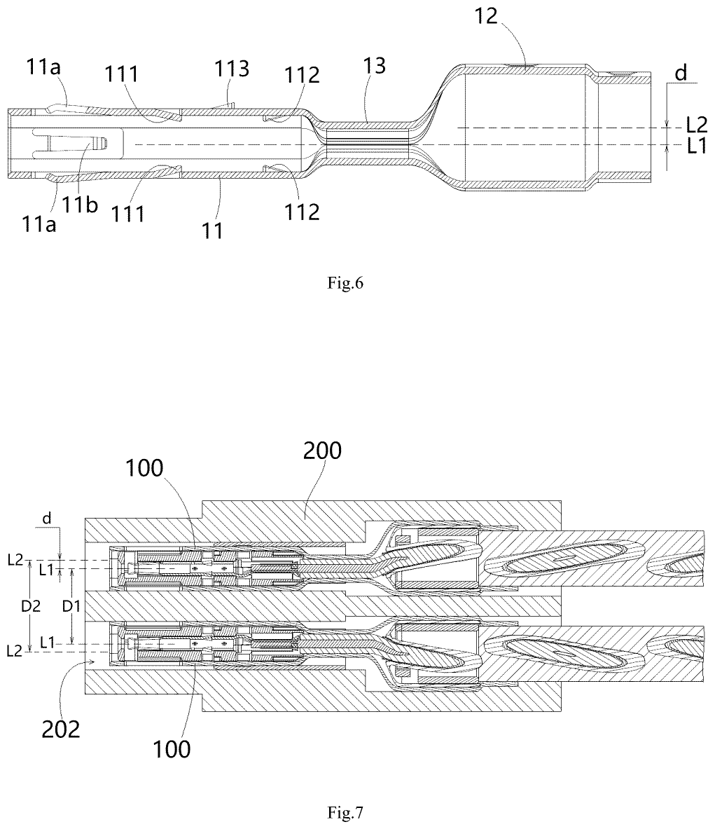

In the illustrated embodiments, the front shell part 11 of the shielding shell 1 is offset to one side relative to the rear shell part 12 of the shielding shell 1, so that the central axis L1 of the front shell part 11 of the shielding shell 1 is spaced at a predetermined distance d from the central axis L2 of the rear shell part 12 of the shielding shell 1, as shown in FIGS. 6 and 7.

As shown in FIGS. 1 to 6, in the illustrated embodiments, the shielding shell 1 further includes a middle shell part 13, which is neck shaped and connected between the front shell part 11 and the rear shell part 12 to achieve a smooth transition between the front shell part 11 and the rear shell part 12.

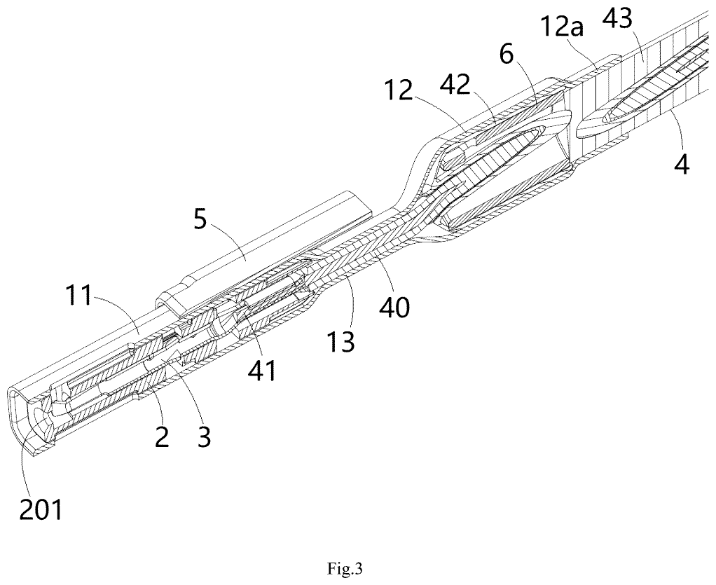

As shown in FIG. 3, in the illustrated embodiments, the cable 4 comprises a core wire 40, one end of which is exposed from the shielding layer 42 of the cable 4 and kept in the middle shell part 13 of the shielding shell 1, and the rear end of the terminal 3 is crimped onto the exposed conductor core 41 of the core wire 40.

As shown in FIG. 3, in the illustrated embodiments, the connector terminal module further comprises a support tube 6, which is provided in the rear shell part 12 of the shielding shell 1 and fitted onto the exposed shielding layer 42 of the cable 4. A portion of the exposed shielding layer 42 of the cable 4 is folded backwards on the outer side of the support tube 6 and pressed between the rear shell part 12 and the support tube 6, and the rear end portion 12a of the rear shell part 12 is crimped onto the outer insulation layer 43 of the cable 4.

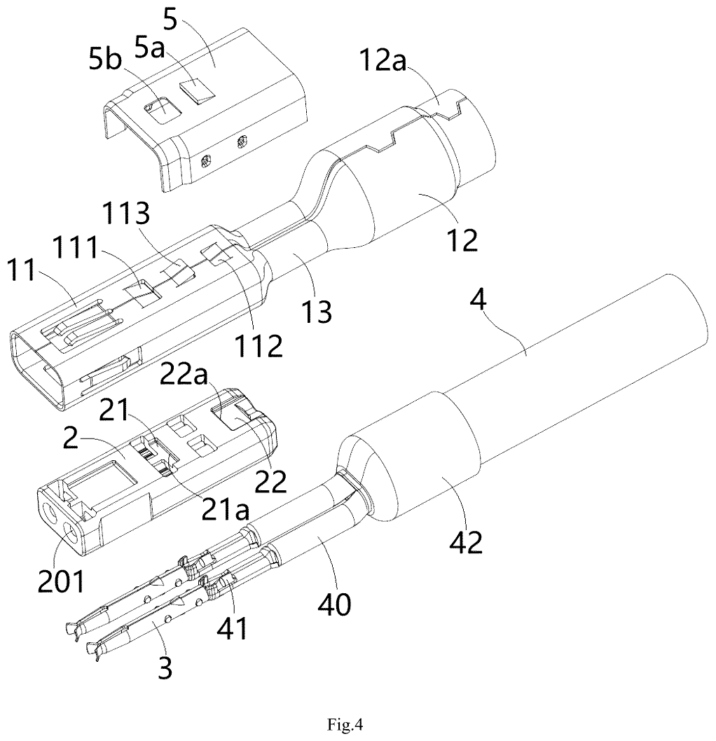

As shown in FIG. 4, in the illustrated embodiments, the cable 4 comprises a pair of core wires 40, the connector terminal module 100 comprises a pair of terminals 3, and the retaining body 2 comprises a pair of terminal holes 201 arranged side by side in the transverse direction of the retaining body 2. The pair of terminals 3 are respectively inserted into the pair of terminal holes 201 of the retaining body 2 and respectively electrically connected to the conductor cores 41 of the pair of core wires 40.

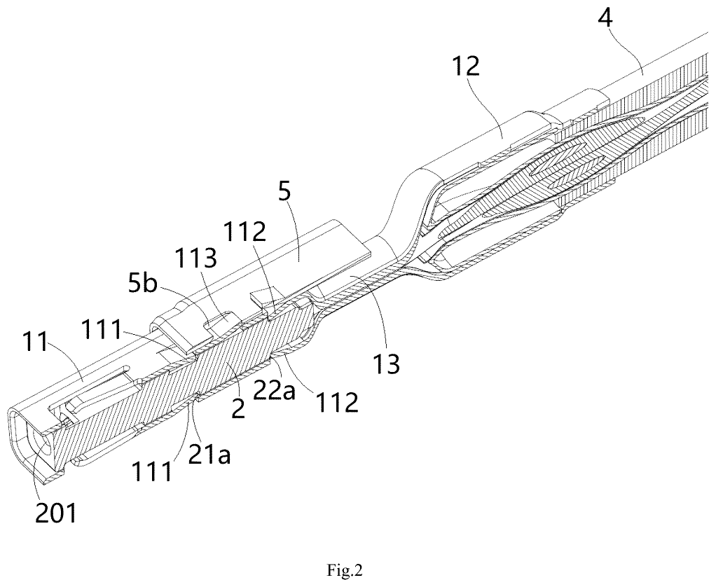

As shown in FIGS. 2 and 4, in the illustrated embodiments, elastic buckles are respectively formed on the top and bottom walls of the front shell part 11 of the shielding shell 1, and concave parts are respectively formed on the top and bottom surfaces of the retaining body 2. The clastic buckles are respectively engaged with the concave parts to lock the retaining body 2 in the front shell part 11.

In the illustrated embodiments shown in FIGS. 2 and 4 to 6, the elastic buckles comprise a first elastic buckle 111 and a second elastic buckle 112 that are spaced from each other in the longitudinal direction of the shielding shell 1, and the concave parts comprise a first concave part 21 and a second concave part 22 respectively engaged with the first elastic buckle 111 and the second elastic buckle 112. In the illustrated embodiments, the first elastic buckle 111 is located in front of the second elastic buckle 112, the rear end face of the first elastic buckle 111 is against the first inner side surface 21a of the first concave part 21, and the front end face of the second elastic buckle 112 is against the second inner side surface 22a of the second concave part 22.

As shown in FIGS. 4 to 6, in the illustrated embodiments, an elastic cantilever is formed on the front shell part 11 of the shielding shell 1, the elastic cantilever is used for electrical contact with a mating shielding shell of a mating connector. In the illustrated embodiments, the clastic cantilever includes a first elastic cantilever 11a and a second clastic cantilever 11b. The first elastic cantilever 11a is formed on each of the top and bottom walls of the front shell part 11 of the shielding shell 1. The second elastic cantilever 11b is formed on each of the left and right walls of the front shell part 11 of the shielding shell 1. In the illustrated embodiments, the first elastic cantilever 11a extends forward from its root, the second elastic cantilever 11b extends backward from its root, and the root of the first elastic cantilever 11a is adjacent to the end of the second elastic cantilever 11b in the longitudinal direction.

As shown in FIGS. 1 and 2, in the illustrated embodiments, the connector terminal module 100 further includes a locking member 5, which is installed on the outer side of the shielding shell 1 to lock the connector terminal module 100 into the connector housing 200 (see FIG. 7). In the illustrated embodiments, an elastic locking piece 5a is formed on the top wall of the locking member 5, the elastic locking piece 5a is adapted to be locked to the connector housing 200 to prevent the connector terminal module 100 from being pulled out of the connector housing 200.

As shown in FIGS. 2 and 4, in the illustrated embodiments, a slot hole 5b is formed on the top wall of the locking member 5, and a third clastic buckle 113 is formed on the top wall of the front shell part 11 of the shielding shell 1. The third elastic buckle 113 is engaged with the slot hole 5b to lock the locking member 5 onto the shielding shell 1.

FIG. 7 shows a longitudinal sectional view of a connector according to an exemplary embodiment of the present invention. The connector includes a connector terminal module 100 and a connector housing 200. The connector housing 200 is formed with an installation hole 202. The connector terminal module 100 is inserted into the installation hole 202.

As shown in FIG. 7, in the illustrated embodiments, the front shell part 11 of the shielding shell 1 is offset to one side relative to the rear shell part 12 of the shielding shell 1, so that the central axis L1 of the front shell part 11 of the shielding shell 1 is spaced at a predetermined distance d from the central axis L2 of the rear shell part 12 of the shielding shell 1. The connector housing 200 includes a pair of installation holes 202, the connector includes a pair of connector terminal modules 100, and the pair of connector terminal modules 100 are respectively inserted into the pair of installation holes 202. The front shell parts 11 of the shielding shells 1 of the pair of connector terminal modules 100 are biased towards each other, so that the distance DI between the central axes LI of the front shell parts 11 of the shielding shells 1 of the pair of connector terminal modules 100 is less than the distance D2 between the central axes L2 of the rear shell parts 12 of the shielding shells 1 of the pair of connector terminal modules 100, and the difference between the two is equal to twice the predetermined distance d.

In the aforementioned exemplary embodiments of the present invention, the shielding shell is an integral stamped piece, which simplifies the assembly of connector terminal module, reduces manufacturing costs, and also improves shielding effectiveness and signal transmission speed.

In addition, in some exemplary embodiments according to the present invention, the shielding shell adopts an eccentric design, which can reduce the spacing between a pair of connector terminal modules.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal module, comprising:
a retaining body having a terminal hole;
a terminal disposed in the terminal hole of the retaining body;
a cable having a conductor core electrically connected to the terminal; and
a shielding shell including a front shell part fitted onto the retaining body and a rear shell part crimped onto an end of the cable, the front shell part and the rear shell part of the shielding shell are opposite to each other in a longitudinal direction of the shielding shell, the shielding shell is an integral stamped piece.

2. The connector terminal module according to claim 1, wherein the front shell part of the shielding shell is biased to one side relative to the rear shell part of the shielding shell, a central axis of the front shell part of the shielding shell is spaced at a predetermined distance d from a central axis of the rear shell part of the shielding shell.

3. The connector terminal module according to claim 2, wherein the shielding shell includes a middle shell part, the middle shell part is neck shaped and connected between the front shell part and the rear shell part.

4. The connector terminal module according to claim 3, wherein the cable has a core wire, an end of the core wire is exposed from a shielding layer of the cable and retained in the middle shell part of the shielding shell, and a rear end of the terminal is crimped onto an exposed conductor core of the core wire.

5. The connector terminal module according to claim 4, further comprising a support tube disposed in the rear shell part of the shielding shell and sheathed on an exposed shielding layer of the cable, a portion of the exposed shielding layer is folded backwards on an outer side of the support tube and pressed between the rear shell part and the support tube, and a rear end portion of the rear shell part is crimped onto an outer insulation layer of the cable.

6. The connector terminal module according to claim 4, wherein the core wire is one of a pair of core wires of the cable, the terminal is one of a pair of terminals, and the terminal hole is one of a pair of terminal holes arranged side by side in a transverse direction of the retaining body, the terminals are respectively inserted into the pair of terminal holes of the retaining body and respectively electrically connected to the conductor cores of the pair of core wires.

7. The connector terminal module according to claim 1, wherein a plurality of elastic buckles are respectively formed on a top wall and a bottom wall of the front shell part, and a plurality of concave parts are respectively formed on a top surface and a bottom surface of the retaining body, the elastic buckles are respectively engaged with the concave parts to lock the retaining body in the front shell part.

8. The connector terminal module according to claim 7, wherein the elastic buckles include a first elastic buckle and a second elastic buckle that are spaced from each other in the longitudinal direction of the shielding shell, the concave parts include a first concave part and a second concave part that are respectively engaged with the first elastic buckle and the second elastic buckle.

9. The connector terminal module according to claim 8, wherein the first elastic buckle is located in front of the second elastic buckle, and a rear end face of the first elastic buckle is against a first inner surface of the first concave part, while a front end face of the second elastic buckle is against a second inner surface of the second concave part.

10. The connector terminal module according to claim 1, wherein a plurality of elastic cantilevers are formed on the front shell part of the shielding shell, the elastic cantilevers electrically contact a mating shielding shell of a mating connector.

11. The connector terminal module according to claim 10, wherein the elastic cantilevers include a plurality of first elastic cantilevers respectively formed on a top wall and a bottom wall of the front shell part of the shielding shell.

12. The connector terminal module according to claim 11, wherein the elastic cantilevers include a plurality of second elastic cantilevers respectively formed on a left wall and a right wall of the front shell part of the shielding shell.

13. The connector terminal module according to claim 12, wherein each of the first elastic cantilevers extends forward from a root of the first elastic cantilever, each of the second elastic cantilevers extends backward from a root of the second elastic cantilever, and the root of each of the first elastic cantilever is adjacent to an end of one of the second elastic cantilevers in the longitudinal direction.

14. The connector terminal module according to claim 1, further comprising a locking member installed on an outer side of the shielding shell to lock the connector terminal module into a connector housing.

15. The connector terminal module according to claim 14, wherein an elastic locking piece is formed on a top wall of the locking member, the elastic locking piece is lockable to the connector housing to prevent the connector terminal module from being pulled out of the connector housing.

16. The connector terminal module according to claim 14, wherein a slot hole is formed on a top wall of the locking member, and a third elastic buckle is formed on a top wall of the front shell part of the shielding shell, the third elastic buckle is engaged with the slot hole to lock the locking member to the shielding shell.

17. A connector, comprising:
a connector housing formed with an installation hole; and
a connector terminal module disposed in the installation hole, the connector terminal module includes:
a retaining body having a terminal hole;
a terminal disposed in the terminal hole of the retaining body;
a cable having a conductor core electrically connected to the terminal; and
a shielding shell including a front shell part fitted onto the retaining body and a rear shell part crimped onto an end of the cable, the front shell part and the rear shell part of the shielding shell are opposite to each other in a longitudinal direction of the shielding shell, the shielding shell is an integral stamped piece.

18. The connector according to claim 17, wherein the front shell part of the shielding shell is biased to a side relative to the rear shell part of the shielding shell, a central axis of the front shell part of the shielding shell is spaced at a predetermined distance from a central axis of the rear shell part of the shielding shell.

19. The connector according to claim 18, wherein the installation hole is one of a pair of installation holes of the connector housing, the connector terminal module is one of a pair of connector terminal modules, and the connector terminal modules are respectively inserted into the installation holes.

20. The connector according to claim 19, wherein the front shell parts of the shielding shells of the connector terminal modules are biased towards each other, a distance between a pair of central axes of the front shell parts of the shielding shells of the pair of connector terminal modules is less than a distance between a pair of central axes of the rear shell parts of the shielding shell parts of the pair of connector terminal modules, a difference between the distances is equal to twice the predetermined distance.
